(19) United States
(12) Patent Application Publication
(10) Pub. No.: US 2024/0156687 A1
(43) Pub. Date: May 16, 2024

(54) MEDICINE DISPENSING APPARATUS

(71) Applicant: TOSHO, INC., Tokyo (JP)

(72) Inventor: Yoshihito Omura, Tokyo (JP)

(21) Appl. No.: 18/552,237

(22) PCT Filed: Mar. 31, 2022
(86) PCT No.: PCT/JP2022/016945

§ 371 Date: Sep. 25, 2023

(30) Foreign Application Priority Data
Apr. 2, 2021 (JP) 2021-063585

(51) Int. Cl. A61J 7/00; B65B 5/10

(52) U.S. Cl. CPC A61J 7/0084; B65B 5/103

(57) ABSTRACT

A medicine dispensing apparatus includes: a medicine guide structure mounted in a medicine feeder storage portion in which a large number of medicine feeders are mounted and which can be drawn out of a housing; a medicine collecting structure provided below the medicine guide structure; a packing device provided below the medicine collecting structure; and a temporary reserving structure mounted between the medicine guide structure and the medicine collecting structure. An electric motor is disposed in front of the temporary reserving structure to open and close the structure. A front-side portion of a lower end portion of an inner wall portion of the medicine guide structure, located above the electric motor, is located in rear of a front-side portion of an upper end portion of the structure.

### TECHNICAL FIELD

The present invention relates to a medicine dispensing apparatus that includes a large number of medicine feeders configured to contain medicines such as tablets, which may be individually discharged and consecutively discharge the medicines, as classified by type, and that automatically discharges and to dispenses desired medicines according to a prescription or a medicine dispensation instruction. In particular, the present invention relates to a medicine dispensing apparatus including a temporary reserving structure between a medicine collecting structure and a medicine collecting structure.

### BACKGROUND ART

Many medicine dispensing apparatuses (see Patent Documents 1 to 7, for example) that are practically used include: a housing; a plurality of medicine feeders configured to contain medicines and consecutively discharge the medicines, and a plurality of medicine feeder storage units each configured to store the plurality of medicine feeders; a medicine guide structure disposed between a pair of adjacent medicine feeder storage units to guide the medicines discharged from the plurality of medicine feeders included in the pair of medicine feeder storage units to a single outlet port located at a lower part of the medicine guide structure; and a medicine feeder storage portion configured to store the pair of medicine feeder storage units and the medicine guide structure.

In the medicine dispensing apparatuses according to the related art, one or more medicines of one or more types are discharged from medicine feeders containing such medicines according to a medicine dispensation instruction, the discharged medicine or medicines are led downward by the medicine guide structure at applicable locations, and thereafter a plurality of medicines having fallen from the medicine guide structure are collected by a medicine collecting structure and put into a packing device located under the medicine collecting structure so that the prescribed medicines are consecutively packed according to the types of medicines.

Medicine dispensing apparatuses including a temporary reserving structure between a medicine guide structure and a medicine collecting structure are also practically used (see Patent Documents 1 to 5 and 7, for example).

While some temporary reserving structures are of a dependent type which are mounted in a medicine feeder storage portion and are drawable together with medicine feeders (see Patent Documents 3 to 5, for example), other temporary reserving structures are of an independent type which are mounted under a medicine feeder storage portion and are not necessarily drawn together with medicine feeders (see Patent Document 1, for example).

Irrespective of the medicine type, there are common operation characteristics that tend to cause the packing device to wait for a long time until completion of input of medicines since fluctuations between upper medicine feeders and lower medicine feeders in the length of the medicine fall path from the medicine feeders to the medicine collecting structure and hence the falling time of discharged medicines are increased when the number of rows of the medicine feeders in the medicine feeder storage portion is increased.

The operation characteristics can be addressed by providing the temporary reserving structure, which can isolate the effect of the fluctuations in the falling time of discharged medicines in the medicine guide structure located above from the medicine collecting structure and hence the packing device located below.

Therefore, in the medicine dispensing apparatus including the temporary reserving structure, the number of rows of the medicine feeders in the medicine feeder storage portion can be increased without adversely affecting the performance of the packing device.

### RELATED-ART DOCUMENT

### Patent Document

Patent Document 1: Japanese Unexamined Patent Application Publication No. 2001-087353 (JPA2001-087353)
Patent Document 2: Japanese Unexamined Patent Application Publication No. 2011-182890 (JPA 2011-182890)
Patent Document 3: Japanese Unexamined Patent Application Publication No. 2012-135388 (JPA 2012-135388)
Patent Document 4: Japanese Unexamined Patent Application Publication No. 2013-078525 (JPA 2013-078525)
Patent Document 5: Japanese Unexamined Patent Application Publication No. 2013-085666 (JPA 2013-085666)
Patent Document 6: Japanese Unexamined Patent Application Publication No. 2021-029378 (JPA 2021-029378)
Patent Document 7: U.S. Pat. No. 10,052,260 (WO 2013-51313)

### SUMMARY OF INVENTION

### Technical Problem

In the medicine dispensing apparatuses, not only the large number of medicine feeders mounted above, but also the temporary reserving structure located below must be switched between a state of holding medicines and a state of allowing medicines to fall, according to control by a control device. Therefore, in any of the medicine dispensing apparatuses according to the related art, switching is made between a state of holding medicines and a state of allowing medicines to fall as driven by an electric motor.

Regarding the switching operation, the individual medicine feeders do not operate very frequently since only medicine feeders containing medicines to be dispensed need to operate while medicine feeders containing medicines other than those to be dispensed do not need to operate. On the contrary, the temporary reserving structure operates frequently since the temporary reserving structure operates every time packing is performed as with the packing device, irrespective of the type of the medicines. As a result, the electric motor also operates frequently, and maintenance work such as check and repair of the electric motor also needs to be performed frequently.

Thus, the packing device which includes a plurality of electric motors generally occupies the lower portion of the housing, and is structured to allow the electric motors to be exposed by drawing the device forward together with a support substrate. Therefore, the electric motors of the packing device can be maintained from both the front side and a lateral side and thus with a light work burden.

On the contrary, the drive system of the temporary reserving structure, including a power transmission member and an electric motor, is disposed deep inside the housing, since higher priority is given to the work of cleaning medicine dust etc., which is frequently performed by the user by drawing the medicine guide structure and the medicine collecting structure forward out of the housing. The electric motor and the power transmission member remain inside the housing even in medicine dispensing apparatuses in which an open-close member as a main component of the temporary reserving structure can be drawn forward out of the housing (see Patent Documents 4, 5, and 7, for example). Therefore, the work of maintaining the electric motor of the temporary reserving structure is basically performed from the rear side or a rear lateral side of the housing.

However, large devices such as medicine dispensing apparatuses are often installed side by side along a wall in pharmacies or, even when installed away from a wall, disposed back to back with other devices. Therefore, there are only a few situations in which the electric motor of the temporary reserving structure can be easily maintained from the rear side of the housing and, even when the maintenance work is performed from a rear lateral side of the housing, the work is often performed in a narrow space or after temporarily moving a relatively light device etc. disposed nearby, which increases the burden of the maintenance work.

It is an object of the present invention to provide a medicine dispensing apparatus that facilitates maintenance work for an electric motor of a temporary reserving structure.

### Solution to Problem

A medicine dispensing apparatus according to the present invention includes: a housing 10A; a plurality of medicine feeders 13 configured to contain medicines and consecutively discharge the medicines, and a plurality of medicine feeder storage units 131, 132 each configured to store the plurality of medicine feeders 13; a medicine guide structure 20 disposed between a pair of adjacent medicine feeder storage units 131, 132 to guide the medicines discharged from the plurality of medicine feeders 13 included in the pair of medicine feeder storage units 131, 132 to a single outlet port located at a lower part of the medicine guide structure 20; a medicine feeder storage portion 12A to 12C configured to store the pair of medicine feeder storage units 131, 132 and the medicine guide structure 20; a temporary reserving structure 60 including a reserving portion 65 configured to temporarily reserve the medicines that have fallen from the outlet port of the medicine guide structure 20 and an open-close mechanism (62 to 64) operable to bring the reserving portion 65 to a reservable state when a closing drive force is applied and to bring the reserving portion 65 to a release state to allow the medicines to be released downward from the reserving portion 65 when an opening drive force is applied, the temporary reserving structure 60 being provided for each medicine guide structure 20; a medicine collecting structure 30 disposed in the housing 10A under the temporary reserving structure to collect the medicine having fallen from the temporary reserving structure; a drive mechanism (51, 52, 70) operable to provide the closing drive force or the opening drive force to the open-close mechanism (62 to 64) of the temporary reserving structure; and a packing device provided in the housing under the medicine collecting structure 30 to pack the medicines discharged from the medicine collecting structure 30.

In the present invention, a front-side portion 22 of a lower end portion of an inner wall portion of the medicine guide structure 20 is located in rear of a front-side portion 21 of an upper end portion of the inner wall portion of the medicine guide structure 20; and a front end of the reserving portion 65 of the temporary reserving structure 30 is located in rear of a front surface of the housing. An electric motor 51 in the drive mechanism operable to provide the closing drive force or the opening drive force is located in front of the reserving portion 65. When configured in this manner, some of the medicines discharged from the plurality of medicine feeders are guided along the inner wall portion located on the front side of the medicine guide structure 20 to fall into the reserving portion 65, even when the electric motor 51 is disposed in front of the reserving portion 65 of the temporary reserving structure 30. As a result, the medicines can be reliably introduced from the plurality of medicine feeders into the reserving portion 65, even if the electric motor 51 is disposed in front of the reserving portion 65. In addition, the electric motor 51 can be easily maintained since the electric motor 51 of the drive mechanism is disposed on the front side of the temporary reserving structure 30. That is, with the present invention, maintenance work for the electric motor of the temporary reserving structure can be performed from a location other than a rear-side location of the medicine dispensing apparatus, thereby enhancing the degree of freedom in the maintenance work and thus solving the technical issue discussed above.

The present invention is also applicable when the plurality of medicine feeder storage portions 12A to 12C are arranged side by side in the housing 10A. In this case, a transmission shaft 64a may be provided to extend in a front-rear direction along the reserving portion 65 of the temporary reserving structure provided for the medicine guide structure 20 in any one of the plurality of medicine feeder storage portions 12A to 12C; and a transmission mechanism 70 operable to transmit motion of the transmission shaft 64a to a plurality of open-close mechanisms of a plurality of temporary reserving structures provided for the plurality of medicine feeder storage portions 12A to 12C may be disposed in rear of the reserving portion inside the housing 10. The electric motor drives the transmission shaft. With such a configuration, the plurality of temporary reserving structures can be driven by the single electric motor by transmitting drive of the electric motor rearward via the transmission shaft, even if the installation location of the electric motor is changed from the rear to the front. As a result, the electric mechanism 70 is allowed to remain deep inside the housing as in the related art, advantageously reducing the burden of modification such as change in structure or members.

Preferably, the electric motor 51 is located in front of the reserving portion 65 of the temporary reserving structure in one of the plurality of medicine feeder storage portions 12A to 12C that is located closest to a side in the housing. With such a configuration, the electric motor is provided in front of a temporary reserving structure that is located closest to a side when a plurality of temporary reserving structures are provided. Thus, maintenance work for the electric motor of the temporary reserving structure can be clearly performed from a front-side lateral location in addition to the front side, further enhancing the degree of freedom in the maintenance work.

Preferably, the transmission shaft 64a serves as a support shaft for the open-close mechanism of the temporary reserving structure. When the support shaft for the temporary reserving structure also serves as a transmission shaft, it is not necessary to add a transmission shaft, avoiding an increase in the number of members which tends to incur an increase in the burden of cost and design.

A cam mechanism operable to convert motion for one rotation of an output shaft of the electric motor 51 into reciprocal rotational motion of the transmission shaft 64a may be provided between the electric motor 51 and the transmission shaft 64a, and the transmission mechanism 70 may be composed of a link mechanism. With such a configuration, it is not necessary that the electric motor should be a highly precise one, or that the electric motor should be finely controlled, since a cam mechanism which tends to allow play is used as a transmission portion, even if the follower mechanism is composed of a link mechanism which tends to involve play. Thus, it is possible to avoid and suppress a cost increase.

### BRIEF DESCRIPTION OF DRAWINGS

FIG. 1 illustrates the structure of a medicine dispensing apparatus according to a first embodiment of the present invention, in which FIG. 1A is an exterior perspective view, FIG. 1B is a schematic view illustrating the internal structure, FIG. 1C is an exterior perspective view in which the leftmost medicine feeder storage portion has been drawn out, FIG. 1D is a schematic view illustrating the internal structure of a rear-side portion of the leftmost medicine feeder storage portion, and FIG. 1E is a schematic view illustrating the internal structure of a front-side portion of the leftmost medicine feeder storage portion.

FIG. 2A is a left side view of a medicine feeder storage portion and a temporary reserving structure storage portion, and FIG. 2B is a vertical sectional left side view of a medicine guide structure and a temporary reserving structure.

FIGS. 3A to 3C are a plan view, a front view, and a vertical sectional view, respectively, of a single temporary reserving structure and a drive mechanism therefor.

FIGS. 4A to 4C are a plan view, a front view, and a vertical sectional view, respectively, of the single temporary reserving structure and the drive mechanism therefor.

FIGS. 5A to 5C are a plan view, a front view, and a vertical sectional view, respectively, of the single temporary reserving structure and the drive mechanism therefor.

FIG. 6A is a plan view of a plurality of temporary reserving structures and a drive mechanism and a power transmission link mechanism therefor, and FIGS. 6B and 6C are each a front view of the link mechanism.

FIG. 7 is an exterior perspective view in which the leftmost medicine feeder storage portion has been drawn out and a left side plate of a medicine storage portion has been removed.

### DESCRIPTION OF EMBODIMENTS

A medicine dispensing apparatus according to an embodiment of the present invention will be described in detail below with reference to the drawings.

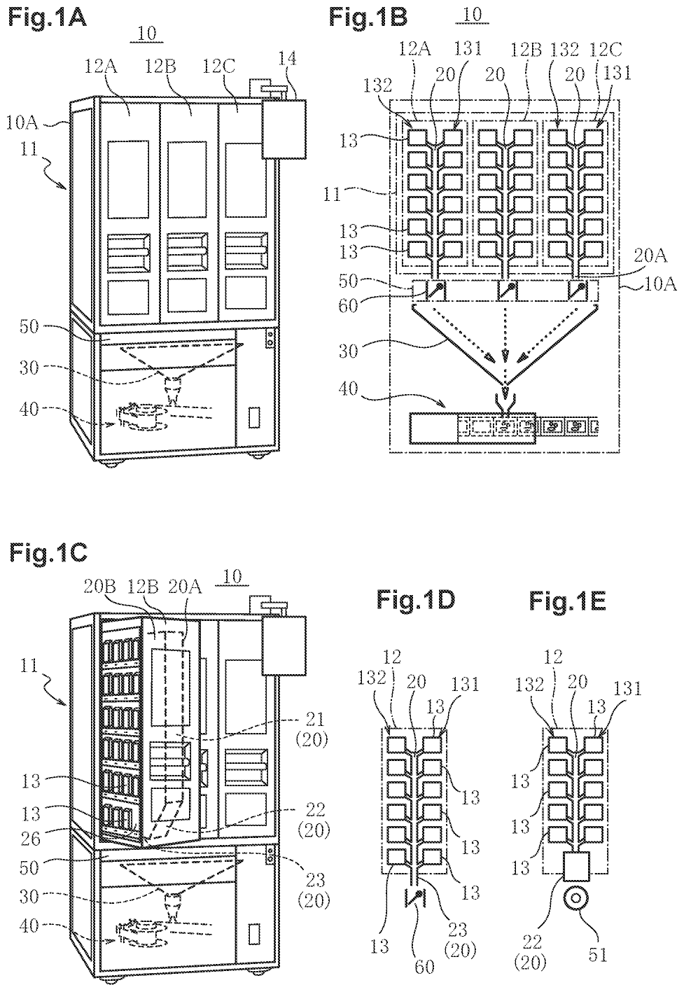

The embodiment illustrated in FIGS. 1 to 7 embodies the present invention. In illustrating the embodiment, fasteners such as bolts, couplers such as hinges, electric circuits such as motor drivers, electronic circuits such as controllers, etc. are not illustrated for simplicity etc., and elements required for or associated with the description of the invention are mainly illustrated.

FIG. 1 illustrates the overall structure of a medicine dispensing apparatus 10. FIG. 1A is an exterior perspective view, FIG. 1B is a schematic view illustrating the internal structure, and FIG. 1C is an exterior perspective view in which a leftmost medicine feeder storage portion 12A has been drawn out forward.

FIG. 1D is a schematic view illustrating the internal structure of a rear-side portion of the leftmost medicine feeder storage portion 12A, and FIG. 1E is a schematic view illustrating the internal structure of a front-side portion of the leftmost medicine feeder storage portion 12A.

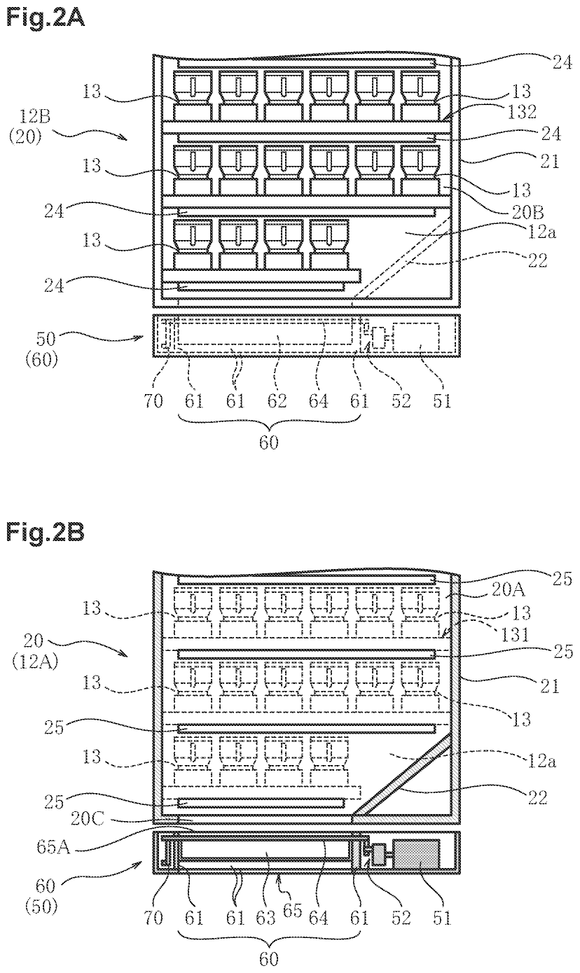

FIG. 2A is a left side view of the medicine feeder storage portion 12A and a temporary reserving structure storage portion 50, and FIG. 2B is a vertical sectional left side view of a medicine guide structure 20 and a temporary reserving structure 60.

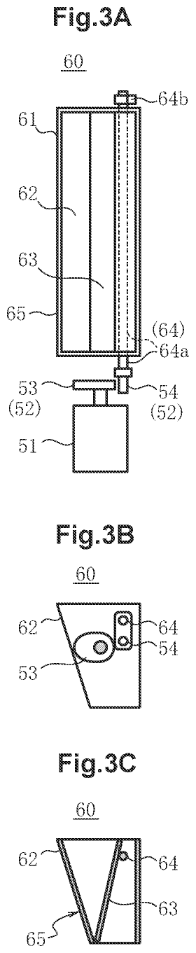

FIGS. 3A to 3C, 4A to 4C, and 5A to 5C are each a set of a plan view, a front view, and a vertical sectional view arranged from top to bottom, whereby the plan view A in the upper part of each drawing illustrates the temporary reserving structure 60 at the lower end portion of the leftmost medicine feeder storage portion 12A and a drive mechanism (51 to 54) operable to directly drive the temporary reserving structure 60; the front view B in the middle part illustrates the temporary reserving structure 60 and a part 53, 54 of the drive mechanism; and the front view C in the lower part is a vertical sectional view of a reserving portion of the temporary reserving structure 60.

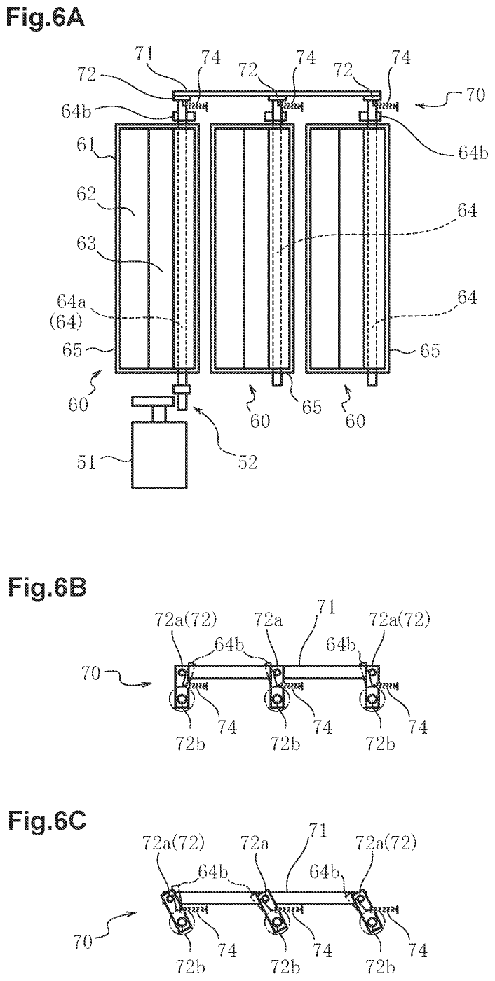

FIG. 6A is a plan view of a plurality of temporary reserving structures 60, 60, 60 and a drive mechanism (51 to 54) and a power transmission link mechanism 70 therefor, and FIGS. 6B and 6C are each a front view of the link mechanism 70.

The medicine dispensing apparatus 10 (see FIG. 1) is obtained by improving a part of the medicine dispensing apparatuses discussed earlier and thus includes, as with such medicine dispensing apparatuses (also see Patent Documents 1 to 5 and 7), a medicine storage 11 in the upper portion of a housing 10A, and a medicine collecting structure 30 and a packing device 40 disposed vertically in the lower portion of the housing. In the present example (see FIG. 1), the temporary reserving structure storage portion 50 is also disposed in the lower portion of the housing 10A, and located above the medicine collecting structure 30 and directly below the medicine storage 11. The medicine storage 11 includes a plurality of (three in the present example) medicine feeder storage portions 12A to 12C, which are disposed transversely side by side and can be individually drawn forward out of the medicine storage 11, as necessary, during replenishment with medicines, maintenance work, etc.

The medicine feeder storage portions 12A to 12C each store: a plurality of medicine feeders 13 configured to contain medicines and consecutively discharge the medicines, and a plurality of medicine feeder storage units 131, 132 each configured to store the plurality of medicine feeders 13; and a medicine guide structure 20 disposed between a pair of adjacent medicine feeder storage units 131, 132 to guide the medicines discharged from the plurality of medicine feeders 13 included in the pair of medicine feeder storage units 131, 132 to a single outlet port 20A located at a lower part of the medicine guide structure 20.

In the illustrated example (see FIGS. 1 and 2), a medicine feeder storage unit 132 (see the indication in the solid line in FIG. 2A) in which six rows and six columns of medicine feeders 13 are disposed is disposed on the left side, and a medicine feeder storage unit 131 (see the indication in the broken line in FIG. 2B) in which six rows and six columns of medicine feeders 13 are disposed is also disposed on the right side, in the medicine feeder storage portion 12B at the middle.

The medicine feeder storage units 131 and 132 of the medicine feeder storage portions 12A and 12C on the left and right sides are provided with a medicine feeder mount avoiding portion 12a, in which the medicine feeders 13 are not provided (see FIGS. 2A and 2B), in order to avoid interference with an inclined plate 22 provided at a front-side portion of the lower end portion of the medicine guide structure 20. The inclined plate 22 of the medicine guide structure 20 fulfills the function to guide medicines having fallen from above to the outlet port 20A configured to face an inlet opening portion 65A of a reserving portion 65 of the temporary reserving structure 60.

It is only necessary that the medicine feeders 13 should each be able to collectively contain a large number of medicines and consecutively discharge the contained medicines, one at a time, according to control by a controller (not illustrated), and the medicine feeders 13 may be medicine feeders of a cassette mount-unmount type exclusively for specific tablets or medicine feeders of an integral fixed type adaptable to many types of tablets (see Patent Document 6, for example).

The medicine dispensation instruction etc. for the controller can be given through communication from a medicine dispensing server etc. (not illustrated), or can be manually input via a touch panel 14. The controller displays the state of operation of the medicine dispensing apparatus 10, information for a medicine dispensing person, etc. on the touch panel 14.

The medicine guide structure 20 (see FIGS. 1 and 2) has a box shape in which a sliding-down passage is provided between two side walls 20A and 20B. One medicine guide structure 20 is integrated in each of the medicine feeder storage portions 12A, 12B, and 12C. The medicine guide structure 20 is configured to receive medicines, discharged from the large number of medicine feeders 13 disposed in the left and right medicine feeder storage units 131 and 132, in the hollow inside from six medicine guide path sliding-down ports 25, formed in the side walls 20A and 20B along the medicine feeder rows at intervals in the vertical direction, guide the medicines downward, and allow the medicines to fall. The left and right medicine feeder storage units 131 and 132 include six medicine guide path sliding-down plates 24 provided under shelf portions on which the medicine feeders 13 are mounted and at intervals in the vertical direction to lead the medicines discharged from the medicine feeders 13 to the medicine guide path sliding-down ports 25.

The medicine collecting structure 30 (see FIG. 1) is a large funnel-shaped member, and is located below the plurality of medicine feeder storage portions 12A to 12C of the medicine storage 11, and configured to collect medicines having fallen from the large number of medicine feeders 13, . . . , and 13 mounted in the medicine feeder storage portions 12A to 12C by way of the plurality of medicine guide structures 20 and further by way of the plurality of temporary reserving structures 60 and to put the medicines into the packing device 40 under the medicine collecting structure 30.

The packing device 40 is provided under the medicine collecting structure 30 discussed above, and operable to separately pack medicines in a packing band according to control by the controller when medicines converged to a falling position by the medicine collecting structure 30 fall to get into the packing device 40 from the medicine collecting structure 30.

In the present example, the temporary reserving structure storage portion 50 which stores the plurality of temporary reserving structures is also integrated in a lower part of the housing, in which the packing device 40 and the medicine collecting structure 30 discussed above are housed. The temporary reserving structure storage portion 50 is disposed above the medicine collecting structure 30, and mounted between the medicine guide structures 20 and the medicine collecting structure 30.

The temporary reserving structure storage portion 50 includes a number of temporary reserving structures 60, the number being the same as that of the medicine guide structures 20, and the medicine guide structures 20 and the temporary reserving structures 60 are disposed to be located vertically to make a one-to-one correspondence (see FIG. 1).

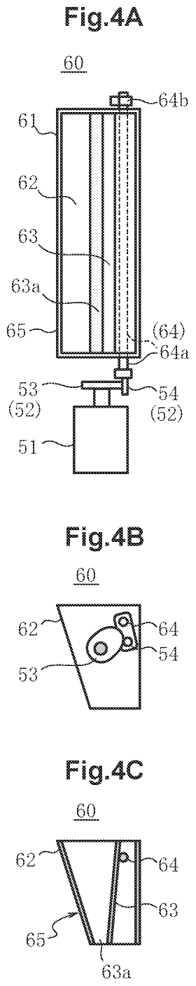

The temporary reserving structure 60 (see FIG. 3) includes a body frame 61 elongated in the front-rear direction and opening upward, an oblique plate 62 fixed as one side wall of the body frame 61, an open-close member 63 facing the oblique plate 62 and capable of opening and closing the lower surface of the body frame 61, and a support shaft 64 coupled to the upper end of the open-close member 63. The support shaft 64 is driven to axially rotate in a limited range to swing the open-close member 63, in order to close the opened lower surface of the body frame 61 (see FIGS. 3A and 4A), open the lower surface to cause an opening 63a to appear (see FIG. 3B), and further make the opening 63a larger (see FIG. 3C). The reserving portion 65 is constituted by the body frame 61, the oblique plate 62, and the open-close member 63. In the present embodiment, a drive mechanism (51, 52, 70) provides a closing drive force or an opening drive force to an open-close mechanism (62 to 64) of the temporary reserving structure 60.

When medicines discharged from the large number of medicine feeders 13 fall down while being guided by the medicine guide structure 20 over the temporary reserving structure 60, the temporary reserving structure 60 receives the medicines in the closed state, temporarily reserves the medicines, and allows the medicines to fall down into the medicine collecting structure 30 by collectively releasing the reserved medicines from the opening 63a by opening the lower surface at an appropriate timing. Temporary reservation by the temporary reserving structure 60 resolves fluctuations in the medicine collection time due to fluctuations in the discharge timing among the medicine feeders 13, differences in the fall path length among the medicine guide structures 20, and hence fluctuations in the falling time, allowing medicines for each packing set to collectively fall together into the medicine collecting structure 30. This serves to speed up medicine dispensation by shortening the input waiting time of the packing device 40.

These basic constituent portions are generally based on those according to the related art. In the medicine dispensing apparatus 10 according to the present embodiment, while being based on the basic configuration, an electric motor 51 operable to drive the temporary reserving structure 60 is located in front of the temporary reserving structure 60 (see FIGS. 1D, 1E, 2, 3 to 5, and 6A), rather than in rear of the temporary reserving structure 60, unlike the related art.

The electric motor 51 is preferably integrated at an end portion in the left-right direction in the housing 10A. In the present example (see FIG. 4A), the electric motor 51 is installed only in front of the temporary reserving structure 60 corresponding to the medicine feeder storage portion 12A located at the left end.

A cam mechanism 52 for power transmission is provided between a rotation output shaft of the electric motor 51 and the front end portion of a support shaft 64 (64a) of the temporary reserving structure 60 located in rear of the electric motor 51.

Each time a driver (cam) 53 of the cam mechanism 52 is caused to make one rotation by the electric motor 51, a follower (following element) 54 of the cam mechanism 52 is swung by several tens of degrees, and accordingly the support shaft 64 is reciprocally axially rotated by the same angle, and accordingly the open-close member 63 opens and closes the bottom of the temporary reserving structure 60 (see FIG. 3), switching the medicine reserving state of the temporary reserving structure 60.

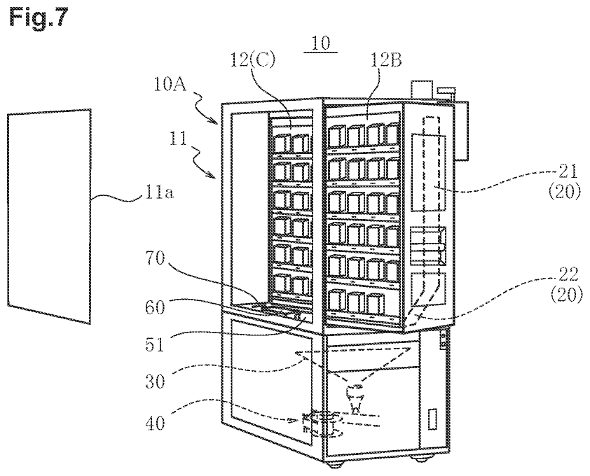

The support shaft 64 is integrated in the temporary reserving structure 60 in the state of extending in the front-rear direction along the temporary reserving structure 60 elongated in the front-rear direction. When the front end portion of the support shaft 64 is axially rotated in a limited range by the electric motor 51 and the cam mechanism 52, the axial rotational motion is transmitted to a rear cam mechanism 64b at the rear end portion of the support shaft 64 (see FIGS. 3A and 4A), and further transmitted from the rear cam mechanism 64b to a swing end portion 72a of a swing member 72 of the link mechanism 70 (see FIGS. 7B and 7C). Thus, the support shaft 64 also serves as a transmission shaft 64a for transmission to the link mechanism 70 (transmission mechanism) located in rear of the temporary reserving structure 60. On the other hand, the support shafts 64 of the other temporary reserving structures 60 corresponding to the other medicine feeder storage portions 12B and 12C serve as follower shafts configured to receive drive of the link mechanism 70 (see FIG. 4). The cam mechanism 52 is configured to convert motion for one rotation of the output shaft of the electric motor 51 into partial reciprocal rotational motion of the transmission shaft 64a.

Further, in order to enable the arrangement relationship discussed above, that is, the arrangement in which the drive mechanism (51 to 54) including the electric motor 51 is located in front of the temporary reserving structure 60, without breaking a basic requirement that medicines having fallen from the medicine guide structures 20 should be reliably put into the temporary reserving structures 60 under the medicine guide structures 20, at least the medicine feeder storage portion 12A at the left end and the corresponding medicine guide structure 20 (see FIGS. 1 and 2) are subjected to a further requirement that is not required for the medicine feeder storage portion 12B at which the electric motor 51 is not disposed or the corresponding medicine guide structure 20.

Specifically (see FIGS. 1C to 1E and 2), a front-side portion (specifically, the inclined plate 22) of a lower end portion of an inner wall portion of the medicine guide structure 20 integrated in the medicine feeder storage portion 12A at which the electric motor 51 is disposed is located in rear of a front-side portion 21 at an upper end portion or an intermediate portion of the inner wall portion of the medicine guide structure 20. The upper end of the front-side portion (22) of the lower end portion of the inner wall portion of the medicine guide structure 20 is connected to the lower end of the front-side portion 21 at the upper end portion or the intermediate portion of the inner wall portion of the medicine guide structure 20, and the lower end of the front-side portion 22 at the lower end portion of the inner wall portion of the medicine guide structure 20 is retracted to a location immediately above the front end of the body frame 61 of the temporary reserving structure 60 located therebelow. As a result, when medicines discharged from the medicine feeders 13 in the upper row are led to the internal space of the medicine guide structure 20 by the medicine guide path sliding-down plate 24 to fall to the medicine feeder mount avoiding portion 12a, the medicines get into the temporary reserving structure 60 with the falling direction of the medicines being changed obliquely rearward by the upper surface of the inclined plate of the front-side portion (inclined plate 22) at the lower end portion of the inner wall portion of the medicine guide structure 20, since the front-side portion (inclined plate 22) of the lower end portion of the inner wall portion of the medicine guide structure 20 is inclined.

The link mechanism 70 (see FIGS. 2 and 6) is a transmission mechanism operable to transmit axial rotational motion, for a limited angle, of the transmission shaft 64a driven by the cam mechanism 52, which converts motion for one rotation of the output shaft of the electric motor 51 into swing motion, to the support shafts 64 of the two temporary reserving structures 60 corresponding to the other medicine feeder storage portions 12B and 12C by way of the rear cam mechanisms 64b. The link mechanism 70 is provided deep inside the housing 10A, and located in rear of the plurality of (three in the present example) temporary reserving structures 60. The link mechanism 70 (see FIG. 6) includes a rod-like coupling member 71 elongated transversely, three short swing members 72 disposed to make a one-to-one correspondence with the three temporary reserving structures 60, and three biasing springs 74 disposed to make a one-to-one correspondence with the plurality of swing members 72. The swing end portion 72a of the swing member 72 is coupled to the coupling member 71 in an axially rotatable state, and a swing support portion 72b of the swing member 72 is coupled to a support member (not illustrated) provided deep inside the housing 10A in an axially rotatable state.

When the transmission shaft 64a, that is, the leftmost support shaft 64, is axially rotated in a limited range against the reaction force of the biasing spring 74, the other support shafts 64, 64 are also axially rotated accordingly (see FIG. 4C). When rotational drive of the transmission shaft 64a is stopped, all the support shafts 64, 64, 64 including the support shaft 64a are returned to the original state by the biasing force of the biasing springs 74 (see FIG. 4B). Therefore, each time the output shaft of the electric motor 51 makes one rotation, the cam mechanism 52, the transmission shaft 64a, and the link mechanism 70 operate to swing all the open-close members 63, and consequently open-close operation is performed in all the temporary reserving structures 60, 60, 60.

The use and the operation of the medicine dispensing apparatus 10 according to the above embodiment will be described with reference to the drawings. FIG. 7 is an exterior perspective view in which the leftmost medicine feeder storage portion 12A, among the three medicine feeder storage portions 12A to 12C, has been drawn forward out of the medicine storage 11 and a left side plate 11a of the medicine storage 11 has been removed.

The method of use and the dispensing operation of the medicine dispensing apparatus 10 are basically similar to those of the medicine dispensing apparatuses according to the related art. The medicine feeder storage portions 12A to 12C are drawn forward out of the medicine storage 11, a large number of medicine feeders 13 exposed are filled with predetermined medicines, and then the medicine feeder storage portion 12A is pushed back into the medicine storage 11. After that, when a medicine dispensation instruction is given by operating the touch panel 14, indicated medicines are discharged from the medicine feeders 13 containing such medicines, led by the medicine guide structures 20 to the temporary reserving structures 60 under the medicine guide structures 20, and temporarily retained there.

Then, the electric motor 51 causes the output shaft thereof to make one rotation after the lapse of an appropriate time. The open-close members 63 of all the temporary reserving structures 60 are swung via the cam mechanism 52, the transmission shaft 64a, and the link mechanism 70 in response to rotation of the electric motor 51. As a result, all the medicines retained by the temporary reserving structures 60 fall together from the temporary reserving structure storage portion 50 to be led to the packing device 40 by the medicine collecting structure 30. In this manner, the medicines are separately packed in a package body one after another. In that event, the medicine fall path from the medicine feeders 13 to the temporary reserving structures 60 and the medicine fall path from the temporary reserving structures 60 to the packing device 40 are separated by open-close operation of the temporary reserving structures 60 for most of the time, and therefore fall of medicines on the side of the medicine guide structures 20 and fall of medicines on the side of the medicine collecting structure 30 can be mostly performed concurrently, thereby reducing the dispensing time.

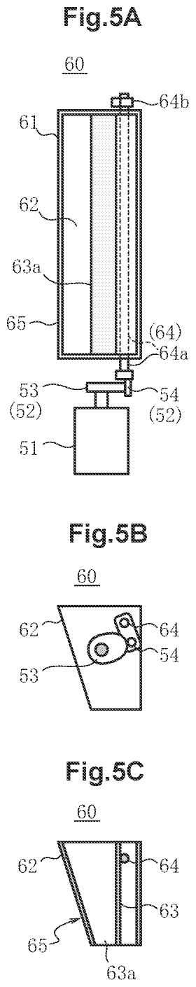

When it becomes necessary to perform regular check, troubleshooting, etc. for the electric motor 51 after repeatedly performing such medicine dispensing operation, the medicine feeder storage portion 12A in which the electric motor 51 is disposed is drawn forward out of the medicine storage 11, and the left side plate 11a is removed from the medicine storage 11 (see FIG. 5). Then, the electric motor 51 installed at a front-side location immediately on the inner side of the left side surface of the medicine dispensing apparatus 10 is exposed, and thus, maintenance work for the electric motor 51 is performed from the front portion of the side surface of the medicine dispensing apparatus 10.

In this manner, with the medicine dispensing apparatus 10 according to the present embodiment, manual work for the electric motor 51 can be performed without going to the rear side of the housing 10A, and thus maintenance work for the electric motor 51 can be easily performed.

### [Others]

While the electric motor 51 is provided only under the leftmost one of the medicine feeder storage portions 12A to 12C in the above embodiment, a suitable installation location of the electric motor 51 is not limited thereto, and may be under the rightmost medicine feeder storage portion 12C, or an electric motor may be installed at both such locations so that targets are driven in a distributed manner.

While a manual medicine dispensing device (manual tablet dispensing device) is not integrated in the medicine dispensing apparatus in the above example, a manual medicine dispensing device may be integrated in the medicine dispensing apparatus according to the present invention (see Patent Document 1, for example). In that case, the medicine dispensing apparatus can be compactly implemented, even under a condition that the medicine feeder storage portions can be drawn out forward, by arranging the manual medicine dispensing device side by side with the temporary reserving structure storage portion 50, although such an arrangement is not essential.

### INDUSTRIAL APPLICABILITY

With the present invention, maintenance work for an electric motor of a temporary reserving structure can be performed from a location other than a rear-side location of a medicine dispensing apparatus, thereby enhancing the degree of freedom in the maintenance work.

### DESCRIPTION OF REFERENCE NUMERALS

10 medicine dispensing apparatus
11 medicine storage
11a side plate
12A to 12C medicine feeder storage portion
12a medicine feeder mount avoiding portion
13 medicine feeder
14 touch panel (operation input portion, display portion)
20 medicine guide structure
21 front-side portion of upper end portion or intermediate portion
22 inclined plate (front-side portion of lower end portion)
24 medicine guide path sliding-down plate
25 medicine guide path sliding-down port
26 medicine feeder non-mount portion
30 medicine collecting structure
40 packing device
50 temporary reserving structure storage portion
51 electric motor
52 cam mechanism
53 driver (driving side)
54 follower (driven side)
60 temporary reserving structure
61 body frame
62 oblique plate
63 open-close member
63a opening
64 support shaft
64a transmission shaft (support shaft)
64b rear cam mechanism
70 link mechanism (transmission mechanism)
71 coupling member
72 swing member
72a swing end portion
72b swing support portion
74 biasing spring

1. A medicine dispensing apparatus comprising:
a housing;
a plurality of medicine feeders configured to contain medicines and consecutively discharge the medicines, and a plurality of medicine feeder storage units each configured to store the plurality of medicine feeders;
a medicine guide structure disposed between a pair of adjacent medicine feeder storage units to guide the medicines discharged from the plurality of medicine feeders included in the pair of medicine feeder storage units to a single outlet port located at a lower part of the medicine guide structure;
a medicine feeder storage portion configured to store the pair of medicine feeder storage units and the medicine guide structure;
a temporary reserving structure including a reserving portion configured to temporarily reserve the medicines that have fallen from the outlet port of the medicine guide structure and an open-close mechanism operable to bring the reserving portion to a reservable state when a closing drive force is applied and to bring the reserving portion to a release state to allow the medicines to be released downward from the reserving portion when an opening drive force is applied, the temporary reserving structure being provided for each medicine guide structure;
a medicine collecting structure disposed in the housing under the temporary reserving structure to collect the medicine having fallen from the temporary reserving structure;
a drive mechanism operable to provide the closing drive force or the opening drive force to the open-close mechanism of the temporary reserving structure; and
a packing device provided in the housing under the medicine collecting structure to separately pack the medicines discharged from the medicine collecting structure, wherein:
a front-side portion of a lower end portion of an inner wall portion of the medicine guide structure is located in rear of a front-side portion of an upper end portion of the inner wall portion of the medicine guide structure;
a front end of the reserving portion of the temporary reserving structure is located in rear of a front surface of the housing; and
an electric motor in the drive mechanism operable to provide the closing drive force or the opening drive force is located in front of the reserving portion.

2. The medicine dispensing apparatus according to claim 1, wherein:
the plurality of medicine feeder storage portions are arranged side by side in the housing;
a transmission shaft is provided to extend in a front-rear direction along the reserving portion of the temporary reserving structure provided for the medicine guide structure in any one of the plurality of medicine feeder storage portions;
a transmission mechanism operable to transmit motion of the transmission shaft to a plurality of open-close mechanisms provided for the plurality of medicine feeder storage portions is disposed in rear of the reserving portion inside the housing; and
the electric motor drives the transmission shaft.

3. The medicine dispensing apparatus according to claim 2, wherein
the electric motor is located in front of the reserving portion of the temporary reserving structure in one of the plurality of medicine feeder storage portions that is located closest to a side in the housing.

4. The medicine dispensing apparatus according to claim 3, wherein
the transmission shaft serves as a support shaft for the open-close mechanism of the temporary reserving structure.

5. The medicine dispensing apparatus according to claim 2, wherein
a cam mechanism operable to convert motion for one rotation of an output shaft of the electric motor into reciprocal rotational motion of the transmission shaft is provided between the electric motor and the transmission shaft, and the transmission mechanism is composed of a link mechanism.

6. The medicine dispensing apparatus according to claim 3, wherein
a cam mechanism operable to convert motion for one rotation of an output shaft of the electric motor into reciprocal rotational motion of the transmission shaft is provided between the electric motor and the transmission shaft, and the transmission mechanism is composed of a link mechanism.

7. The medicine dispensing apparatus according to claim 4, wherein
a cam mechanism operable to convert motion for one rotation of an output shaft of the electric motor into reciprocal rotational motion of the transmission shaft is provided between the electric motor and the transmission shaft, and the transmission mechanism is composed of a link mechanism.
